(19) United States
(12) Patent Application Publication
(10) Pub. No.: US 2017/0157803 A1
(43) Pub. Date: Jun. 8, 2017

(54) POLYPROPYLENE FILM AND MOLD RELEASE FILM

(71) Applicant: Toray Industries, Inc., Tokyo (JP)

(72) Inventors: Takuya Kuma, Otsu-shi (JP); Kazuma Okada, Otsu-shi (JP); Yasuyuki Imanishi, Otsu-shi (JP); Masatoshi Ohkura, Otsu-shi (JP)

(21) Appl. No.: 15/320,822

(22) PCT Filed: Jul. 6, 2015
(86) PCT No.: PCT/JP2015/069428

§ 371 Date: Dec. 21, 2016

(30) Foreign Application Priority Data
Jul. 9, 2014 (JP) 2014-141166

(51) Int. Cl. B29C 33/68; B32B 27/32

(52) U.S. Cl. CPC B29C 33/68; B32B 27/32; B29K 2823/12; B29K 2995/0077; B29K 2995/0072

(57) ABSTRACT

A polypropylene film includes a surface layer (I) with polypropylene as a main component at least on one face of a base layer. Surface free energy of the surface layer (I) is 15 mN/m or more and less than 28 mN/m. A mold release film includes a polypropylene film including a surface layer (I) with polypropylene as a main component at least on one face of a base layer, wherein surface free energy of the surface layer (I) is 15 mN/m or more and less than 28 mN/M.

### TECHNICAL FIELD

This disclosure relates to a polypropylene film that can suitably be used as a mold release film excellent in mold releasability, surface roughness uniformity, and productivity.

### BACKGROUND

Polypropylene films are excellent in transparency, mechanical characteristics, electric characteristics, and the like and are used in various uses such as packaging uses, mold release uses, taping uses, electric uses such as cable wrapping and capacitors. Polypropylene films are excellent in surface mold releasability and mechanical characteristics in particular and are suitably used as mold release films or process films for various members such as plastic products, building materials, and optical members.

Characteristics required for mold release films are set as appropriate depending on their uses. In recent years, polypropylene films may be used as cover films for resin layers having adhesiveness such as a photosensitive resin. When a resin layer having adhesiveness is covered, when the mold releasability of a cover film is poor, the cover film cannot be peeled off neatly when it is peeled off, which may change the shape of the resin layer, which is a face to be protected, or leave peeling marks on the face to be protected. When the surface free energy of the cover film is lower, the mold releasability is better. The surface free energy of the cover film is determined by the type of a polymer forming the film; the surface free energy of the polypropylene films that have conventionally been used is about 29 to 32 mN/m (refer to Japanese Patent Application Laid-open Nos. 2013-226410, 2011-152733, 2007-126644 and H02-284929, for example).

Japanese Patent Application Laid-open No. 2011-140594 describes an example of a film that blends polymethyl pentene and the like into a base resin such as polypropylene as means for improving mold releasability, for example. Although using polymethyl pentene, a fluorine-based resin, or a silicone resin can improve mold releasability (that is, can reduce surface free energy represented by critical surface tension), these resins are costly and may be difficult to be used as cover films used in a disposable manner. When these resins are kneaded into polypropylene, although surface free energy decreases in some degree, fish eyes or the like may occur owing to poor compatibility with polypropylene.

Although Japanese Patent Application Laid-open No. 2000-117900 describes an example that reduces surface free energy by surface irregularities, mold releasability is insufficient. In JP '900, the irregularities are formed by coating or the like in post-treatment, whereby costs may increase.

It could therefore be helpful to provide a polypropylene film and a mold release film that are excellent in mold releasability, surface roughness uniformity, and productivity.

### SUMMARY

We thus provide a polypropylene film including a surface layer (I) with polypropylene as a main component at least on one face of a base layer, surface free energy of the surface layer (I) being 15 mN/m or more and less than 28 mN/m.

The polypropylene film is excellent in mold releasability, surface roughness uniformity, and productivity and can suitably be used as a mold release film.

### DETAILED DESCRIPTION

Our polypropylene film includes a surface layer (I) with polypropylene as a main component at least on one face of a base layer in which the surface free energy of the surface layer (I) is 15 mN/m or more and less than 28 mN/m. The “main component” means that the ratio of a specific component to all the components is 50% by mass or more, more preferably 90% by mass or more, further preferably 95% by mass or more, and most preferably 99% by mass or more. The surface free energy of the surface layer (I) is more preferably 15 mN/m or more and less than 27 mN/m and further preferably 15 mN/m or more and less than 26 mN/m. When the surface free energy is 28 mN/m or more, when the polypropylene film is used as a mold release film for surface protection, the mold release film cannot be peeled off neatly when a face to be protected has high adhesiveness, and the shape of the face to be protected may be changed or peeling marks may be left on the face to be protected. When the surface free energy of the surface layer (I) is lower, mold releasability is better. The polypropylene film has a lower limit of about 15 mN/m. The surface free energy of a film has conventionally been determined by the type of a polymer forming the film. The surface free energy of the polypropylene film is about 29 to 31 mN/m. Although corona treatment or the like has been able to increase the surface free energy to improve wettability, it has been difficult to reduce the surface free energy to improve mold releasability. We finely control the surface state to provide a polypropylene film having excellent mold releasability while having polypropylene as a main component. Setting the surface free energy of the surface layer (I) to be within the range can be achieved by finely controlling the surface state based on a first form or a second form described below.

The contents of polymethyl pentene, a fluorine-based resin and a silicone-based resin in the surface layer (I) are each preferably less than 10% by mass. The contents are each more preferably less than 1% by mass and further preferably less than 0.1% by mass. The materials are most preferably not substantially contained. Polymethyl pentene, the fluorine-based resin, and the silicone-based resin are known as members that are low in surface free energy and excellent in mold releasability; although mold releasability can be improved by using the above materials for the surface layer (I), the above materials are poor in compatibility with polypropylene, and when they are added to the surface layer (I) of the film, for example, they are not neatly dispersed, which may degrade the uniformity of surface roughness and degrade quality. In addition, the above materials are costlier than polypropylene, which may increase materials costs and degrade productivity.

Both the Young's modulus E_{MD} in a longitudinal direction and the Young's modulus E_{TD} in a width direction are preferably 2.0 GPa or more. E_{MD} is more preferably 2.1 GPa or more and further preferably 2.2 GPa or more. E_{MD} is more preferably 2.5 GPa or more, further preferably 3.0 GPa or more, and most preferably 4.0 GPa or more. When E_{MD} and E_{TD} are less than 2.0 GPa, when the polypropylene film is used as the mold release film for surface protection, the film may elongate to break owing to peeling tension, or peeling marks may be left on the face to be protected when the adhesiveness of the face to be protected is high. Although larger E_{MD} and E_{TD} are preferred, their upper limits are substantially about 7 GPa. To set the values of E_{MD} and E_{TD} to be within the ranges, it is preferred that the raw material compositions of the base layer and the surface layer (I) are within the ranges described below, that the film formation conditions are within the ranges described below, and that the film is biaxially stretched with a high ratio to obtain a polypropylene film.

A direction parallel to a film forming direction is referred to as a film forming direction, a longitudinal direction, or an MD direction, whereas a direction orthogonal to the film forming direction within the film plane is referred to as a width direction or a TD direction.

The value of E_{MD}/E_{TD} is preferably 0.2 to 1.5. The value of E_{MD}/E_{TD} is more preferably 0.3 to 1.4 and further preferably 0.4 to 1.3. When the value of E_{MD}/E_{TD} exceeds 1.5, orientation in the longitudinal direction is exceedingly strong, and the film may tear in the longitudinal direction when handled. In contrast, when the value of E_{MD}/E_{TD} is less than 0.2, orientation in the width direction is exceedingly strong, and the film may tear in the width direction. To set the value of E_{MD}/E_{TD} within the range, it is preferred that the raw material compositions of the base layer and the surface layer (I) are set to be within the ranges described below, that the film formation conditions are within the ranges described below, and that the film is biaxially stretched with a high ratio to obtain a polypropylene film.

A 120° C. thermal shrinkage rate in the width direction is preferably 1% or less. The 120° C. thermal shrinkage rate in the width direction is more preferably 0.5% or less and further preferably 0.3% or less. When the 120° C. thermal shrinkage rate in the width direction exceeds 1%, when the polypropylene film passes through a drying process under heating or the like after being laminated with another material, for example, the polypropylene film may become deformed to peel off or wrinkle. The lower limit of the thermal shrinkage rate is not limited to a particular value; considering that the polypropylene film may swell, the lower limit is substantially about −2.0%. To set the thermal shrinkage rate within the range, it is effective that the raw material compositions of the base layer and the surface layer (I) are within the ranges described below, that the film formation conditions are within the ranges described below, and that the thermal fixing and relaxing conditions after the biaxial stretch in particular are within the ranges described below.

A 150° C. thermal shrinkage rate is preferably 0.1 to 20% both in the longitudinal direction and the width direction. The 150° C. thermal shrinkage rate is more preferably 0.5 to 18% and further preferably 0.8 to 15%. When the 150° C. thermal shrinkage rate exceeds 20%, when the polypropylene film is used as a mold release film for press forming, for example, the polypropylene film may become deformed to wrinkle by heat during press forming. When the 150° C. thermal shrinkage rate is less than 0.1%, the polypropylene film may locally swell by heat during press forming, and the excess polypropylene film may be folded to wrinkle. To set the thermal shrinkage rate to within the range, it is effective that the raw material composition of the film is set to the range described below, that the film formation conditions are within the ranges described below, and that the thermal fixing and relaxing conditions after the biaxial stretch in particular are within the ranges described below.

The thickness of the polypropylene film, which is adjusted as appropriate depending on uses and is not limited to a particular thickness, is preferably 0.5 μm or more and 100 μm or less. When the thickness is less than 0.5 μm, handling may be difficult. When the thickness exceeds 100 μm, a resin amount increases, which may degrade productivity. The polypropylene film is excellent in tensile rigidity even when the thickness thereof is reduced, whereby handleability can be maintained. To take full advantage of this feature, the thickness is more preferably 1 μm or more and 40 μm or less, further preferably 1 μm or more and 30 μm or less, and most preferably 1 μm or more and 15 μm or less. The thickness can be adjusted by the screw rotation rate of an extruder, the width of an unstretched sheet, a film forming speed, a stretch ratio, or the like to the extent that the other properties are not impaired.

The polypropylene film can be achieved by the first form and the second form described below. The following first describes the first form.

In the first form of the polypropylene film, a dense network structure containing polypropylene fibrils is formed on the surface of the surface layer (I). To reduce the surface free energy of the surface of a substance, a method of providing irregularities on the surface is known. By forming the dense network structure containing the fibrils, both high surface smoothness and mold releasability can be achieved.

In the first form of the polypropylene film, the center line average roughness Ra of the surface layer (I) is preferably 10 to 150 nm. The center line average roughness Ra of the surface layer (I) is more preferably 10 to 100 nm and further preferably 10 to 60 nm. When Ra exceeds 150 nm, when the polypropylene film is used as a mold release film for an optical member, for example, the surface irregularities of the mold release film may be transferred to the optical member to affect the visibility of a product. Although a lower Ra is preferred, its lower limit is about 10 nm in the first form of the polypropylene film. To set Ra to within the range, it is effective that the lamination configuration of the film and the raw material composition of the surface layer (I) are within the ranges described below, that the film formation conditions are within the ranges described below, and that the extruding condition and the stretching condition in particular are within the ranges described below.

The following describes polypropylene raw materials for suitable use in the first form of the polypropylene film and the configuration of a film containing the raw materials.

The first form of the polypropylene film preferably has a lamination configuration in which the surface layer (I) with polypropylene as a main component is provided at least on one face of the base layer with polypropylene as a main component. The base layer is not limited to a particular material. For the material, known materials such as polyamide, aramid, polyimide, polyamideimide, cellulose, polypropylene, polyethylene, polymethyl pentene, nylon, and polyethylene terephthalate can be employed singly or in combination of two or more. To not cause peeling from the surface layer (I) and improve handleability such as the strength and stiffness of the film, the base layer is preferably a biaxially stretched film with polypropylene as a main component, whereas the surface layer (I) is preferably a layer forming a dense network structure containing polypropylene fibrils to impart mold releasability. The reason why mold releasability improves by forming the network structure is considered that air is present in microscopic gaps in between the fibrils forming the network structure, and a contact area with an adherend can be reduced when the polypropylene is used as a protective film.

The following describes a polypropylene raw material A for suitable use in the base layer of the first form.

The polypropylene raw material A is preferably a polypropylene having a cold xylene soluble portion (hereinafter, CXS) of 4% by mass or less and a mesopentad fraction of 0.95 or more. Failure to satisfy these criteria may degrade film forming stability or degrade film tensile rigidity.

The cold xylene soluble portion (CXS) refers to a polypropylene component dissolved in xylene when the film is completely dissolved in xylene and is then precipitated at room temperature and is believed to correspond to a component that is difficult to crystallize for some reasons such as being low in stereoregularity and molecular weight. When such a component is contained much in the resin, the film may be inferior in tensile rigidity. For this reason, the CXS is preferably 4% by mass or less, further preferably 3% by mass or less, and particularly preferably 2% by mass or less. Although a lower CXS is preferred, the lower limit thereof is about 0.1% by mass. To obtain a polypropylene having such a CXS, examples include a method of enhancing catalytic activity when the resin is obtained and a method of cleaning the obtained resin with a solvent or a propylene monomer itself.

From a similar viewpoint, the mesopentad fraction of the polypropylene raw material A is preferably 0.95 or more and more preferably 0.97 or more. The mesopentad fraction is an indicator indicating the stereoregularity of a polypropylene crystalline phase measured by the nuclear magnetic resonance (NMR). The value being higher is preferred because the degree of crystallinity is high, and the melting point is high, giving suitability for use at high temperatures. The upper limit of the mesopentad fraction is not limited to a particular value. To obtain a resin having such high stereoregularity, preferred examples include a method of cleaning resin powder obtained by a solvent such as an n-heptane, a method of appropriately selecting a catalyst and/or a catalytic promoter and selecting a composition.

The melt flow rate (MFR) of the polypropylene material A is preferably 1 to 10 g/10 minutes in view of film formability and film tensile rigidity. The MFR is an indicator indicating the melt viscosity of a resin prescribed in JIS K 7210 (1995) and is a property value indicating a characteristic of a polyolefin resin. The MFR indicates a value measured at 230° C. and 2.16 kgf. The melt flow rate (MFR) is particularly preferably 2 to 5 g/10 minutes. To set the MFR to the above value, examples include a method of controlling average molecular weight or molecular weight distribution.

Although the polypropylene raw material A mainly contains a propylene homopolymer, a copolymerization component by another unsaturated hydrocarbon or the like may be contained, or a polymer in which propylene is not single may be blended to the extent that desired characteristics are not impaired. Examples of the copolymerization component and a monomer component forming a blend include ethylene, propylene (for a copolymerized blend), 1-butene, 1-pentene, 3-methylpentene-1, 3-methylbutene-1, 1-hexene, 4-methylpentene-1, 5-ethylhexane-1, 1-octene, 1-decene, 1-dodecene, vinylcyclohexene, styrene, allylbenzene, cyclopentene, norbornene, and 5-methyl-2-norbornene. As to a copolymerization amount or blend amount, in view of tensile rigidity, the copolymerization amount is preferably less than 1 mol %, whereas the blend amount is preferably less than 10% by mass.

The following describes a polypropylene raw material B for suitable use in the surface layer (I) of the first form of our film.

The polypropylene raw material B preferably has β crystal forming ability to form a dense network containing polypropylene fibrils. The β crystal forming ability is preferably 30 to 100%. When the β crystal forming ability is less than 30%, the fibril network structure is difficult to be formed when the film is manufactured, and excellent mold releasability cannot necessarily be obtained. To set the β crystal forming ability to 30 to 100%, a polypropylene having a high isotactic index is preferably used, or a β crystal nucleating agent is preferably added. The β crystal forming ability is more preferably 35 to 100% and particularly preferably 40 to 100%.

Preferred examples of the β crystal nucleating agent include alkali or alkaline earth metallic salts of carboxylic acids such as calcium 1,2-hydroxystearate and magnesium succinate, amide-based compounds represented by N,N′-dicyclohexyl-2,6-naphthalene dicarboxamide, tetraoxaspiro compounds such as 3,9-bis[4-(N-cyclohexylcarbamoyl)phenyl]-2,4,8,10-tetraoxaspiro[5,5]undecane, aromatic sulfonic acid compounds such as sodium benzenesulfonate and sodium naphthalenesulfonate, imide carboxylic acid derivatives, phthalocyanine-based pigments, and quinacridone-based pigments. Particularly preferred ones are amide-based compounds disclosed in Japanese Patent Application Laid-open No. H05-310665. The content of the β crystal nucleating agent is preferably 0.05 to 0.5% by mass and more preferably 0.1 to 0.3% by mass based on the entire polypropylene composition. When the content of the β crystal nucleating agent is less than 0.05% by mass, the formation of the β crystal is insufficient, the fibril network structure is difficult to be formed, and excellent mold releasability cannot necessarily be obtained. When the content of the β crystal nucleating agent exceeds 0.5% by mass, flaws may occur with the exceedingly added β crystal nucleating agent as starting points.

For the polypropylene raw material B, an isotactic polypropylene resin with a melt flow rate (hereinafter, denoted as MFR) of 2 to 30 g/10 minutes (230° C., 2.16 kgf) is preferably used in view of extrusion moldability and uniform formation of holes. The isotactic index of the polypropylene raw material B is preferably 90 to 99.9%. The isotactic index of the polypropylene raw material B is more preferably 95 to 99%. When the isotactic index of the polypropylene raw material B is less than 90%, the crystallinity of the resin decreases, which may degrade film formability or make the strength of the film insufficient.

The polypropylene raw material B can be, not to mention homo polypropylene, resins in which an ethylene component or an α-olefin component such as butene, hexene, and octene is copolymerized with polypropylene 5% by mass or less and more preferably 2.5% by mass or less in view of stability and film formability in a film forming process and uniformity in properties. The polypropylene raw material B may contain both homo polypropylene and/or a polypropylene copolymer and a high-molecular weight polypropylene. The polypropylene raw material B preferably contains the high-molecular weight polypropylene of 0.5 to 30% by mass in view of improving strength. The high-molecular weight polypropylene refers to a polypropylene having an MFR of 0.1 to 2 g/10 minutes (230° C., 2.16 kgf); preferred examples thereof include Polypropylene Resin D101 manufactured by Sumitomo Chemical Co., Ltd. and Polypropylene Resins E111G, B241, and E105GM manufactured by Prime Polymer Co., Ltd.

The polypropylene raw material A and the polypropylene raw material B may contain various kinds of additives such as antioxidants, thermal stabilizers, antistatic agents, lubricants containing inorganic or organic particles, antiblocking agents, fillers, and incompatible polymers to the extent that the desired effects are not impaired. For the purpose of reducing oxidation degradation caused by the thermal history of the polypropylene raw material A and the polypropylene raw material B in particular, an antioxidant is preferably contained. The contents of the antioxidant are preferably 2 parts by mass or less, more preferably 1 part by mass or less, and further preferably 0.5 parts by mass or less relative to 100 parts by mass of the polypropylene composition.

The first form of the polypropylene film preferably has a laminated structure in which the surface layer (I) containing the polypropylene raw material B is laminated at least on one face of the base layer containing the polypropylene raw material A. In this structure, the ratio (%) of the thickness of the surface layer (I) to the thickness of the entire polypropylene film is preferably 25% or less, more preferably 23% or less, and further preferably 20% or less. When the ratio of the thickness of the surface layer (I) exceeds 25%, the strength of the polypropylene film decreases, and when the polypropylene film is used as the mold release film for surface protection, the film may elongate to break owing to peeling tension, or peeling marks are left in the face to be protected when the adhesiveness of the face to be protected is high. When the ratio (%) of the thickness of the surface layer (I) is less than 2%, mold releasability may degrade, and the ratio is preferably 2% or more. To set the lamination thickness ratio within the range, it may be adjusted by the screw rotation rates of respective extruders for use in the base layer and the surface layer (I).

In the first form of the polypropylene film, the thickness of the surface layer (I) is preferably 10 μm or less. The thickness of the surface layer (I) is more preferably 5 μm or less and further preferably 3 μm or less. Although the lower limit thereof is not limited to a particular thickness so long as mold releasability is exhibited, the surface layer being exceedingly thin is likely to cause unevenness in lamination, making stable film formation difficult, and the lower limit is substantially about 0.05 μm. When the thickness of the surface layer (I) exceeds 10 μm, when a liquid having low surface tension such as an organic solvent is dropped, the droplet may penetrate into the surface layer (I), and the surface free energy may fail to be measured. When the polypropylene film is used as a protective film for a coating layer or the like in which an organic solvent or the like is left, mold releasability may degrade, or the film may be cleaved when the film is peeled off. To set the thickness of the surface layer (I) within the range, it can be adjusted by the screw rotation rate of an extruder for use in the surface layer (I), the width of an unstretched sheet, a film forming speed, a stretch ratio, or the like.

Although the following describes a method of manufacturing the first form of our polypropylene film, that is not necessarily limiting.

First, the polypropylene raw material A is fed to a single screw extruder for a layer A, the polypropylene raw material B is fed to a single screw extruder for a layer B, and melt extrusion is performed at 200 to 260° C. After removing foreign objects, modified polymers, and the like by a filter installed at some midpoint of a polymer tube, by a multi-manifold-type layer B/layer A/layer B composite T die, the polypropylene raw material A and the polypropylene raw material B are laminated on each other to give a lamination thickness ratio of 1/8/1, for example, and are discharged onto a casting drum to obtain a laminated unstretched sheet having a layer structure of layer B/layer A/layer B. In this process, the surface temperature of the casting drum is preferably 80 to 130° C. in view of improving the mold releasability of the layer B and more preferably 90 to 120° C. By setting the temperature of the casting drum to within the range, β crystals can be generated in the layer B efficiently, the network structure containing fibrils is formed on the film surface in the subsequent longitudinal stretching process and transverse stretching process, and mold releasability can be improved. A technique of adherence to the casting drum may be any of an electrostatic application technique, a technique of adherence using the surface tension of water, an air knife technique, a press roll technique, submerged casting, and the like. In view of planarity, the air knife technique is preferred. The air temperature of an air knife is 25 to 100° C. and preferably 30 to 80° C. The blown air speed is preferably 130 to 150 m/s. To improve uniformity in the width direction, a double tube structure is preferred. To prevent the film from vibrating, the position of the air knife is preferably adjusted as appropriate to cause air to flow toward the downstream side of film formation.

The obtained unstretched sheet is left to cool in the air and is then introduced to the longitudinal stretching process. In the longitudinal stretching process, the unstretched sheet is first brought into contact with a plurality of metallic rolls maintained at 100° C. or more and less than 150° C. to be preliminarily heated to a stretching temperature, is stretched threefold to eightfold in the longitudinal direction, and is then cooled to room temperature. When the stretching temperature is 150° C. or more, the network structure containing fibrils is difficult to be formed on the film surface in the subsequent transverse stretching process, and mold releasability may degrade. When the stretch ratio is less than threefold, mold releasability may similarly degrade, or the orientation of the film may be weak to degrade tensile rigidity.

Next, the longitudinally uniaxially stretched film is guided to a tenter, the ends of the film are gripped by clips, and transverse stretch is stretched sevenfold to 13-fold in the width direction at a temperature of 120 to 165° C. When the stretching temperature is low, the film may break. When the stretching temperature is exceedingly high, the network structure containing fibrils is difficult to be formed on the surface layer, and mold releasability may degrade. When the ratio is high, the film may break. When the ratio is low, the orientation of the film may be weak to degrade tensile rigidity.

In the subsequent heat treatment and relaxing treatment process, while relaxation with a relaxation ratio of 2 to 20% is given in the width direction with the width direction tensely gripped by the clips, the film is thermally fixed at a temperature of 100° C. or more and less than 160° C., is then passed through a cooling process at 80 to 100° C., and is guided to the outside of the tenter. The clips at the ends of the film are released, a film edge is slit in a winder process, and a film product roll is wound.

The following describes the second form of the polypropylene film.

In the second form of the polypropylene film, irregularities controlled to a specific surface shape are formed on the surface of the surface layer (I) with the polypropylene raw material described below as a main component. With this structure, both the uniformity of surface roughness and mold releasability can be achieved.

In the second form of the polypropylene film, the center line average roughness Ra of the surface layer (I) is preferably 200 to 1,000 nm. The center line average roughness Ra of the surface layer (I) is more preferably 200 to 800 nm and further preferably 200 to 500 nm. When Ra is less than 200 nm, the surface is exceedingly smooth, and the effect of improving mold releasability in the second form cannot necessarily be obtained. When Ra exceeds 1,000 nm, the film may be likely to break during film formation, or mold releasability may degrade owing to the exceedingly large Ra. To set Ra within the range, it is effective that the lamination configuration of the film and the raw material compositions of the respective layers are within the ranges described below, that the film formation conditions are within the ranges described below, and that the extruding condition and the stretching condition in particular are within the ranges described below. In the second form of the polypropylene film, the maximum height Rmax of the surface layer (I) is preferably 1,000 to 15,000 nm. The maximum height Rmax of the surface layer (I) is more preferably 1,000 to 10,000 nm and further preferably 1,000 to 5,000 nm. When Rmax is less than 1,000 nm, the surface is exceedingly smooth, and the effect of improving mold releasability in the second form cannot necessarily be obtained. When Rmax exceeds 15,000 nm, the film may be likely to break during film formation, or mold releasability may degrade owing to the exceedingly large Rmax. To set Rmax within the range, it is effective that the lamination configuration of the film and the raw material compositions of the respective layers are within the ranges described below, that the film formation conditions are within the ranges described below, and that the extruding condition and the stretching condition in particular are within the ranges described below.

When the polypropylene film according to the second form is used for a general process film or protective film, the center line average roughness Ra of the surface layer (I) is preferably 200 to 500 nm. The center line average roughness Ra of the surface layer (I) is more preferably 200 to 400 nm and further preferably 200 to 350 nm. When Ra is less than 200 nm, the surface is exceedingly smooth, and the effect of improving mold releasability in the second form cannot necessarily be obtained. In contrast, when Ra exceeds 500 nm, when the polypropylene film is used as a surface protective film for a soft member, for example, the surface irregularities of the film may be transferred to the soft member to adversely affect it. In addition, exceedingly large Ra may degrade mold releasability. To set Ra within the range, it is effective that the lamination configuration of the film and the raw material compositions of the respective layers are within the ranges described below, that the film formation conditions are within the ranges described below, and that the extruding condition and the stretching condition in particular are within the ranges described below.

When the polypropylene film according to the second form is used for a general process film or protective film, the maximum height Rmax of the surface layer (I) is preferably 1,000 nm to 5,000 nm. The maximum height Rmax of the surface layer (I) is more preferably 1,000 to 4,500 nm and further preferably 1,000 to 4,000 nm. When Rmax is less than 1,000 nm, the surface is exceedingly smooth, and the effect of improving mold releasability in the second form cannot necessarily be obtained. When Rmax exceeds 5,000 nm, when the polypropylene film is used as a surface protective film for a soft member, for example, the surface irregularities of the film may be transferred to the soft member to adversely affect it. In addition, exceedingly large Rmax may degrade mold releasability. To set Rmax within the range, it is effective that the lamination configuration of the film and the raw material compositions of the respective layers are within the ranges described below, that the surface layer in particular does not contain any resin not compatible with polypropylene such as polyethylene, polymethyl pentene, a fluorine-based resin, and a silicone-based resin or any resin likely to cause fish eyes caused by the generation of a crosslinked (gel) component, that the film formation conditions are within the ranges described below, and that the extruding condition and the stretching condition in particular are within the ranges described below.

When the polypropylene film according to the second form is used as an aesthetic film in mold press forming or the like, the center line average roughness Ra of the surface layer (I) is preferably 200 to 1,000 nm. The center line average roughness Ra of the surface layer (I) is more preferably 300 to 950 nm and further preferably 400 to 900 nm. By setting Ra to within the range, when the polypropylene film is used as a mold release film for mold press forming, for example, the surface irregularities of the film are transferred to a member, and uniform matte texture can be imparted to the surface of the member, achieving usefulness as the aesthetic film. When Ra is less than 200 nm, the irregularities on the film surface cannot be transferred to the member, and the film cannot necessarily be used as the aesthetic film. When Ra exceeds 1,000 nm, the film may be likely to break during film formation, or mold releasability may degrade owing to the exceedingly large Ra. To set Ra within the range, it is effective that the lamination configuration of the film and the raw material compositions of the respective layers are within the ranges described below, that the film formation conditions are within the ranges described below, and that the extruding condition and the stretching condition in particular are within the ranges described below.

When the polypropylene film according to the second form is used as the aesthetic film in mold press forming or the like, the maximum height Rmax of the surface layer (I) is preferably 5,000 nm to 15,000 nm. The maximum height Rmax of the surface layer (I) is more preferably 8,000 to 15,000 nm, further preferably 10,000 to 15,000 nm, and most preferably 12,000 to 15,000 nm. By setting Rmax within the range, when the polypropylene film is used as the mold release film for mold press forming, for example, the surface irregularities of the film are transferred to a member, and uniform matte texture can be imparted to the surface of the member, achieving usefulness as the aesthetic film. When Rmax is less than 5,000 nm, the irregularities on the film surface cannot be transferred to the member, and the film cannot necessarily be used as the aesthetic film. When Rmax exceeds 15,000 nm, the film may be likely to break during film formation, or mold releasability may degrade owing to the exceedingly large Rmax. To set Rmax to be within the range, it is effective that the lamination configuration of the film and the raw material compositions of the respective layers are within the ranges described below, that the film formation conditions are within the ranges described below, and that the extruding condition and the stretching condition in particular are within the ranges described below.

When the polypropylene film is used as the aesthetic film in mold press forming or the like, a change in the surface roughness before and after press forming is preferably small; letting the maximum height after pressing be Rmax1 and the maximum height before pressing be Rmax2, the value of Rmax1/Rmax2 is preferably 0.5 or more. When the value of Rmax1/Rmax2 is less than 0.5, the irregularities on the surface of the surface layer (I) decrease during press forming, and mold releasability may degrade, or the surface irregularities may fail to be transferred to a product. To set the value of Rmax1/Rmax2 within the range, it is effective that the lamination configuration of the film and the raw material compositions of the respective layers are within the ranges described below, that the film formation conditions are within the ranges described below, and that the extruding condition and the stretching condition in particular are within the ranges described below.

The following describes polypropylene raw materials for suitable use in the second form of the polypropylene film and the configuration of a film containing the raw materials.

The second form of the polypropylene film preferably has a lamination configuration in which the surface layer (I) with polypropylene as a main component is provided at least on one face of the base layer containing polypropylene and particles. The base layer is preferably a biaxially stretched film to improve handleability such as the strength and stiffness of the film and, in addition, preferably contains the particles for the purpose of controlling the surface shape of the surface layer (I). The surface layer (I) is preferably a layer with polypropylene as a main component in which the crystallinity of polypropylene is more preferably high to impart mold releasability. In the second form, irregularities are formed on the surface of the base layer (the interface between the base layer and the surface layer (I)) by the particles contained in the base layer (inner layer), and the thickness of the surface layer (I) is within the range described below, whereby irregularities similar to those on the surface of the base layer can also be formed on the surface of the surface layer (I), and mold releasability can be improved. In addition, it is important that the surface layer (I) does not substantially contain any resin other than polypropylene and particles in view of improving mold releasability.

The following describes a polypropylene raw material C for suitable use in the base layer of the second form.

The polypropylene raw material C preferably contains a polypropylene resin and particles. The polypropylene resin is not limited to a particular polypropylene resin and can be, not to mention homo polypropylene, resins in which an ethylene component or an α-olefin component such as butene, hexene, and octene is copolymerized with polypropylene in the range of 5% by mass or less and more preferably 2.5% by mass or less in view of stability and film formability in the film forming process and uniformity in properties. In view of film strength, homo polypropylene, which is high in crystallinity, is preferably used.

The melt flow rate (MFR) of the polypropylene resin for use in the polypropylene raw material C is preferably 1 to 10 g/10 minutes (230° C., 2.16 kgf) in view of a difference in viscosity from the resin for use in the surface layer and more preferably 2 to 5 g/10 minutes (230° C., 2.16 kgf) in view of film formability and film tensile rigidity. To set the MFR to the above value, examples include a method of controlling average molecular weight or molecular weight distribution.

Although the polypropylene resin for use in the polypropylene raw material C mainly contains a propylene homopolymer, a copolymerization component by another unsaturated hydrocarbon or the like may be contained, or a polymer in which propylene is not single may be blended to the extent that desired characteristics are not impaired. Examples of the copolymerization component and a monomer component forming a blend include ethylene, propylene (for a copolymerized blend), 1-butene, 1-pentene, 3-methylpentene-1, 3-methylbutene-1, 1-hexene, 4-methylpentene-1, 5-ethylhexane-1, 1-octene, 1-decene, 1-dodecene, vinylcyclohexene, styrene, allylbenzene, cyclopentene, norbornene, and 5-methyl-2-norbornene. As to a copolymerization amount or blend amount, in view of tensile rigidity, the copolymerization amount is preferably less than 1 mol %, whereas the blend amount is preferably less than 10% by mass.

The particles for use in the polypropylene raw material C are not limited to particular particles so long as they do not lose their particle shape by shear force or heat in a film forming process and can be inorganic particles or organic particles. Examples of the inorganic particles include metallic oxides such as silica, alumina, titania, and zirconia, barium sulfate, calcium carbonate, aluminum silicate, calcium phosphate, mica, kaolin, and clay. Among them, preferred ones are metallic oxides such as silica, alumina, titania, and zirconia and calcium carbonate. Examples of the organic particles include crosslinked particles of polymethoxysilane-based compounds, crosslinked particles of polystyrene-based compounds, crosslinked particles of acrylic-based compounds, crosslinked particles of polyurethane-based compounds, crosslinked particles of polyester-based compounds, crosslinked particles of fluorine-based compounds, and mixtures thereof.

The average particle diameter of the inorganic particles and the organic particles is preferably 1 to 10 μm. The particle diameter is more preferably 2 to 10 μm, further preferably 3 to 10 μm, and most preferably 4 to 10 μm. When the average particle diameter is less than 1 μm, the surface roughness of the base layer and the surface layer (I) is small, and mold releasability may degrade. When the average particle diameter exceeds 10 μm, the film may be likely to break, or the maximum height Rmax of the surface roughness may be exceedingly large. In a method of measuring the average particle diameter of the inorganic particles, using circular-equivalent diameters obtained from a transmission electron micrograph of the particles through image processing, a weight average diameter is calculated and employed.

The added amount of the particles is preferably 2 to 20 parts by mass with respect to 100 parts by mass of the entire polypropylene raw material C. When the added amount thereof is less than 2 parts by mass, surface roughness is small, and mold releasability may degrade. When the added amount exceeds 20 parts by mass, the film is likely to break, or the maximum height Rmax of the surface layer (I) may be exceedingly large.

The following describes a polypropylene raw material D for suitable use in the surface layer (I) of the second form.

The polypropylene raw material D preferably contains polypropylene as a main component, reduces other components such as additives to a minimum, and contains homo polypropylene, which is high in crystallinity, to obtain high mold releasability. In view of this point, the polypropylene raw material D can preferably be the same as the polypropylene raw material A.

The polypropylene raw material C and the polypropylene raw material D for use in the second form may contain various kinds of additives such as antioxidants, thermal stabilizers, antistatic agents, lubricants containing inorganic or organic particles, antiblocking agents, fillers, and incompatible polymers to the extent that the desired effects are not impaired. For the purpose of reducing oxidation degradation caused by the thermal history of the polypropylene raw material C and the polypropylene raw material D in particular, an antioxidant is preferably contained. The contents of the antioxidant are preferably 2 parts by mass or less, more preferably 1 part by mass or less, and further preferably 0.5 part by mass or less relative to 100 parts by mass of the polypropylene composition.

The second form of the polypropylene film preferably has a laminated structure in which the surface layer (I) containing the polypropylene raw material D is laminated at least on one face of the base layer containing the polypropylene raw material C. In this structure, the ratio (%) of the thickness of the surface layer (I) to the thickness of the entire polypropylene film is preferably 25% or less, more preferably 20% or less, further preferably 15% or less, and most preferably 10% or less. When the ratio of the thickness of the surface layer (I) exceeds 25%, surface roughness is small, and mold releasability may degrade. When the ratio (%) of the thickness of the surface layer (I) is less than 1%, the particles contained in the base layer may break through the surface layer (I) to be exposed to the surface layer to increase the surface free energy; in view of this situation, the ratio of the thickness of the surface layer (I) is preferably 1% or more. To set the lamination thickness ratio to be within the range, it may be adjusted by the screw rotation rates of respective extruders for use in the base layer and the surface layer (I).

In the second form of the polypropylene film, the thickness of the surface layer (I) is preferably 5 μm or less. The thickness of the surface layer (I) is more preferably 3 μm or less and further preferably 1 μm or less. Although the lower limit thereof is not limited to a particular thickness so long as the mold releasability is exhibited, the surface layer being exceedingly thin is likely to cause unevenness in lamination, making stable film formation difficult, and the lower limit is substantially about 0.05 μm. When the thickness of the surface layer (I) exceeds 5 μm, surface roughness decreases, which may degrade mold releasability. To set the thickness of the surface layer (I) within the range, it can be adjusted by the screw rotation rate of an extruder for use in the surface layer (I), the width of an unstretched sheet, a film forming speed, a stretch ratio, or the like.

Although the following describes a method of manufacturing the second form of the polypropylene film, that is not necessarily limiting.

First, the polypropylene raw material C is fed to the single screw extruder for the layer A, the polypropylene raw material D is fed to the single screw extruder for the layer B, and melt extrusion is performed at 200 to 260° C. After removing foreign objects, modified polymers, and the like by a filter installed at some midpoint of a polymer tube, by a multi-manifold-type layer B/layer A/layer B composite T die, the polypropylene raw material C and the polypropylene raw material D are laminated on each other to give a lamination thickness ratio of 1/8/1, for example, and are discharged onto a casting drum to obtain a laminated unstretched sheet having a layer structure of layer B/layer A/layer B. In this process, the surface temperature of the casting drum is preferably 30 to 130° C. A technique of adherence to the casting drum may be any of an electrostatic application technique, a technique of adherence using the surface tension of water, an air knife technique, a press roll technique, submerged casting, and the like. In view of planarity, the air knife technique is preferred. The air temperature of an air knife is 25 to 100° C. and preferably 30 to 80° C. The blown air speed is preferably 130 to 150 m/s. To improve uniformity in the width direction, a double tube structure is preferred. To prevent the film from vibrating, the position of the air knife is preferably adjusted as appropriate to cause air to flow toward the downstream side of film formation.

The obtained unstretched sheet is left to cool in the air and then introduced to the longitudinal stretching process. In the longitudinal stretching process, the unstretched sheet is first brought into contact with a plurality of metallic rolls maintained at 100° C. or more and less than 150° C. to be preliminarily heated to a stretching temperature, is stretched threefold to eightfold in the longitudinal direction, and is then cooled to room temperature. When the stretching temperature is 150° C. or more, unevenness in stretch may occur, or the film may break. When the stretch ratio is less than threefold, unevenness in stretch may occur, or the orientation of the film may be weak to degrade tensile rigidity.

Next, the longitudinally uniaxially stretched film is guided to a tenter, the ends of the film are gripped by clips, and transverse stretch is stretched sevenfold to 13-fold in the width direction at a temperature of 120 to 165° C. When the stretching temperature is low, the film may break. When the stretching temperature is exceedingly high, the rigidity of the film may degrade. When the ratio is high, the film may break. When the ratio is low, the orientation of the film may be weak to degrade tensile rigidity.

In the subsequent heat treatment and relaxing treatment process, while relaxation with a relaxation ratio of 2 to 20% is given in the width direction with the width direction tensely gripped by the clips, the film is thermally fixed at a temperature of 100° C. or more and less than 160° C., then passed through a cooling process at 80 to 100° C., and guided to the outside of the tenter. The clips at the ends of the film are released, a film edge is slit in a winder process, and a film product roll is wound.

The biaxially oriented polypropylene film obtained as described above can be used in various uses such as packaging films, mold release films, process films, sanitary articles, agricultural articles, building articles, and medical articles and can suitably be used as mold release films and process films because of being excellent in mold releasability in particular. The polypropylene film of the second form in particular is excellent in mold releasability and aestheticity and is suitably used as process films for surface shape transfer or mold release films for pressing. When the polypropylene film of the second form is used as a mold release film for mold pressing for a fiber reinforced composite material, for example, fortunately, mold releasability from products after pressing is excellent, and in addition, a matte face can be transferred to products.

The following exemplifies a method of forming a fiber reinforced composite material by mold pressing using the polypropylene film.

First, a prepreg of a fiber reinforced composite material plate is manufactured by a method in accordance with Manufacture Example 1 described below. Next, the polypropylene films are laminated on both faces of the prepreg. Next, the prepreg is pressed by a mold press apparatus for 3 to 30 minutes at 140 to 155° C. and 0.5 to 1.0 MPa to harden the prepreg. The prepreg is taken out of the mold and is returned to room temperature. The polypropylene films are then peeled off to obtain a fiber reinforced composite material.

### EXAMPLES

The following describes our films in detail with reference to examples. The characteristics were measured and evaluated by the following methods.

### (1) Film Thickness

Measurement was performed at five points using a micro thickness meter (manufactured by Anritsu Corporation), and the average thereof was determined.

### (2) Surface Free Energy

Using four types of liquids, or water, ethylene glycol, formamide, and methylene iodide, as measurement liquids, static contact angles relative to the film surface of the respective liquids were determined using a contact angle meter Type CA-D manufactured by Kyowa Interface Science Co., Ltd. The static contact angles were measured after a lapse of 30 seconds from the dropping of the respective liquids onto the film surface. The contact angles obtained for the respective liquids and the respective components of the surface tension of the measurement liquids were substituted into the following equation, and simultaneous equations consisting of four equations were solved for γSd, γSp, and γSh.

(γSd·γLd)1/2+(γSp·γLp)1/2+(γSh·γLh)1/2=γL(1+cos θ)/2

where γS=γSd+γSp+γSh

### γL=γLd+γLp+γLh

γS, γSd, γSp, and γSh represent the surface free energy of the film surface, the dispersion force component thereof, the polarity force component thereof, and the hydrogen bond component thereof, respectively, whereas γL, γLd, γLp, and γLh represent the surface free energy of the used measurement liquid, the dispersion force component thereof, the polarity force component thereof, and the hydrogen bond component thereof, respectively. For the surface tension of the respective used liquids, values suggested by Panzer (J. Panzer, J. Colloid Interface Sci., 44, 142 (1973)) were used.

(3) Young's Moduli (E_{MD} and E_{TD}) in Longitudinal Direction and Width Direction

The polypropylene film was cut into a rectangle of 150 mm in test direction length×10 mm in width to prepare a sample. Using a tensile tester (Tensilon AMF/RTA-100 manufactured by Orientec Corporation), conforming to the method prescribed in JIS-K7127 (1999), measurement was performed five times in an atmosphere of 25° C. and 65% RH to determine an average. An initial inter-chuck distance was set to 50 mm, a tensile speed was set to 300 mm/min, and a point at which the load passed 1 N after the start of the test was set to the origin of elongation.

### (4) Thermal Shrinkage Rate (120° C.)

Five samples, each having a width of 10 mm and a length of 200 mm (a measurement direction), were cut out in the width direction of the film. Marks were placed at positions apart from both ends by 25 mm as reference lines, and the distance between the reference lines was measured by a universal projector to be a sample length l₀. Next, the test specimens were inserted into paper, were heated in an oven maintained at 120° C. for 15 minute with no load, were taken out, and were cooled to room temperature. A dimension (l₁) was measured by the universal projector, and the average of the five values determined by the following equation was determined to be the thermal shrinkage rate:

Thermal shrinkage rate={(l₀−l₁)/l₀}×100(%).

### (5) Surface Roughness of Film (Ra and Rmax)

For the polypropylene film, measurement was performed using a surface roughness meter (SURFCORDER ET4000A manufactured by Kosaka Laboratory Ltd.) based on JIS-B-0601:2001 under the following measurement conditions to determine a center line average roughness SRa (nm) and a maximum height SRmax (nm). The measurement was performed at three points on the surface of the surface layer (I) to determine the average thereof.

### Measurement Conditions

Measurement speed: 0.1 mm/sec
Measurement range: 1,000 μm in the longitudinal direction and 1,000 μm in the width direction
Measurement pitch: 1 μm in the longitudinal direction and 15 μm in the width direction
Cutoff value λc: 0.2 mm
Probe tip radius: 0.5 μm

### (6) Thermal Shrinkage Rate (150° C.)

For the polypropylene film, using TMA/SS6000 manufactured by Seiko Instruments Inc., shrinkage curves in the film longitudinal direction and width direction under a constant load were determined in accordance with the following temperature program. From the obtained shrinkage curves, respective 150° C. thermal shrinkage rates were read.

Temperature program: 25° C.→(5° C./min)→170° C. (held for 5 minutes)

### Load: 2 g

Sample size: 15 mm in sample length×4 mm in width
(A direction to be measured was aligned to the sample length side.)
(7) Surface Roughness after Pressing

Five samples with sides of 10 cm taken from the polypropylene film were overlaid on each other and were pressed by a pressing machine for 3 minutes at 0.6 MPa and 150° C. After that, the five polypropylene films were peeled off from each other, and for the third film among the five films, surface roughness was measured by a method similar to (5). Letting the maximum height after pressing be Rmax1 and the maximum height before pressing be Rmax2, evaluation was performed based on the following criteria:

### Pass: Rmax1/Rmax2≧0.5

### Fail: Rmax1/Rmax2<0.5.

(8) Mold Releasability from Fiber Reinforced Composite Material

Press forming was performed by the method described in Manufacture Example 1 described below, and peelability when the polypropylene film was peeled off from the fiber reinforced composite material by hand was evaluated based on the following criteria:

Pass: The polypropylene film can be peeled off at a constant speed.
Fail: Peeling resistance is rather strong, and the polypropylene film cannot be peeled off at a constant speed. Alternatively, the polypropylene film elongates or breaks when it is peeled off.

### (9) Matte Texture of Fiber Reinforced Material

For the fiber reinforced composite material manufactured by the method described in Manufacture Example 1 described below, the matte texture of the surface was visually observed and evaluated based on the following criteria:

A: The matte texture is particularly strong and favorable.
B: The matte texture is strong.
C: Although the matte texture is weak, the fiber texture of the fiber reinforced composite material cannot be discerned.
D: The fiber texture of the fiber reinforced composite material can visually be discerned.

### Manufacture Example 1

### (1) Manufacture of Epoxy Resin Composition

Twenty parts by mass of “Epikote” (registered trademark) 828, 20 parts by mass of “Epikote” (registered trademark) 834, 25 parts by mass of “Epikote” (registered trademark) 1001 (these resin compositions are bisphenol A-type epoxy resins manufactured by Japan Epoxy Resin Co., Ltd.), 35 parts by mass of “Epikote” (registered trademark) 154 (a phenol novolak-type epoxy resin manufactured by Japan Epoxy Resin Co., Ltd.) as epoxy resin compositions, 4 parts by mass of DICY7 (dicyandiamide manufactured by Japan Epoxy Resin Co., Ltd.) as an amine-based hardener, 3 parts by mass of “Nova Red” (registered trademark) 120 (with an average particle diameter of 25 μm and a phosphorous content of 85% manufactured by Rin Kagaku Kogyo Co., Ltd.) as a phosphorous-based compound, 5 parts by mass of “Omicure” (registered trademark) 24 (2,4-toluene bis(dimethyl urea) manufactured by PTI Japan Ltd.) as a hardening accelerator, and 5 parts by mass of “Vinylec” (registered trademark) K (polyvinyl formal manufactured by Chisso Corporation) as a thermoplastic resin were mixed with each other by a kneader in accordance with the following procedure to obtain an epoxy resin composition in which polyvinyl formal was uniformly dissolved.

(a) The epoxy resin raw materials and polyvinyl formal are stirred for 1 to 3 hours while being heated at 150 to 190° C. to uniformly dissolve polyvinyl formal.
(b) The resin temperature is dropped to 90 to 110° C., the phosphorous-based compound is added thereto, and the mixture is stirred for 20 to 40 minutes.
(c) The resin temperature is dropped to 55 to 65° C., dicyandiamide and 2,4-toluene bis(dimethyl urea) are added thereto, the mixture is kneaded for 30 to 40 minutes at the temperature, and the mixture is taken out of the kneader to obtain the resin composition.

### (2) Manufacture of Prepreg

Next, the prepared resin composition was applied to mold release paper using a reverse roll coater to manufacture a resin film. The resin amount per unit area of the resin film was set to 25 g/m². Next, the resin films were laminated on both faces of carbon fiber Torayca (registered trademark) T700SC-12K-50C (manufactured by Toray Industries, Inc.) unidirectionally aligned in a sheet shape to give a fiber weight per unit area of 100 g/m², and the resin composition was impregnated by applying heat and pressure to manufacture a prepreg.

### (3) Manufacture of Fiber Reinforced Composite Material

The face of the surface layer (I) of each of the polypropylene films manufactured in the following examples and comparative examples was laminated on both faces of the prepreg, was heated and pressurized using a hot press for 3 minutes at 0.6 MPa and 150° C., was taken out of the hot pressing machine, and was cooled to room temperature. Each of the polypropylene films manufactured in the following examples and comparative examples was peeled off to obtain a fiber reinforced composite material with a thickness of about 0.2 mm.

### Example 1

First, raw materials were fed from a measuring hopper to a double screw extruder such that 99.7 parts by mass of Homopolypropylene FLX80E4 manufactured by Sumitomo Chemical Co., Ltd. with a melting point of 165° C. and an MFR of 7.5 g/10 minutes, 0.3 part by mass of N,N′-dicyclohexyl-2,6-naphthalene dicarboxamide (NU-100 manufactured by New Japan Chemical Co., Ltd.), and 0.1 part by mass each of IRGANOX (registered trademark) 1010 and IRGAFOS (registered trademark) 168 manufactured by Ciba Specialty Chemicals as antioxidants would be mixed with this ratio. The mixture was melt-kneaded at 300° C., discharged from a die in a strand shape, cooled and solidified in a 25° C. water tank, and cut into a chip shape to obtain the polypropylene raw material B.

As the polypropylene raw material A for the base layer (the layer A), Crystalline PP (a) (manufactured by Prime Polymer Co., Ltd., TF850H, MFR: 2.9 g/10 minutes, isotactic index: 96%) was fed to a single screw melt extruder for the layer A, as the polypropylene raw material B for the surface layer (I) (the layer B), the above polypropylene raw material B was fed to a single screw melt extruder for the layer B, and melt extrusion was performed at 240° C. After removing foreign objects by a 60 μm cutoff sintered filter, by a feed block-type A/B composite T die, the polypropylene raw material A and the polypropylene raw material B were laminated on each other with a thickness ratio of 8/1 and discharged onto a casting drum the surface temperature of which was controlled to 90° C. to obtain a cast sheet. In this process, the polypropylene raw material B of the surface layer (I) was set to a face being in contact with the casting drum. Next, the film was preliminarily heated at 125° C. using a plurality of ceramic rolls and stretched 4.6-fold in the film longitudinal direction. Next, the film was introduced into a tenter-type stretching machine with its ends gripped by clips, preliminarily heated for 3 seconds at 165° C., and stretched 8.0-fold at 160° C. In the subsequent heat treatment process, the cast sheet was subjected to heat treatment at 160° C. while giving relax with 10% in the width direction, then passed through a cooling process at 130° C., and guided to the outside of the tenter. The clips at the ends of the film were released, and the film wound around a core to obtain a polypropylene film with a thickness of 15 μm. The properties and the evaluation results of the polypropylene film are listed in Table 1.

### Example 2

As the polypropylene raw material C for the base layer (the layer A), 93.3 parts by mass of Crystalline PP (a) (manufactured by Prime Polymer Co., Ltd., TF850H, MFR: 2.9 g/10 minutes, isotactic index: 96%) and 6.7 parts by mass of a master raw material (manufactured by Sankyo Seifun Co., Ltd., 2480K, calcium carbonate particles: 6 μm) obtained by compounding 80% by mass of calcium carbonate and 20% by mass of polypropylene were dry blended to be fed to a single screw melt extruder for the layer A, as the polypropylene raw material D for the surface layer (I) (the layer B), Crystalline PP (a) (manufactured by Prime Polymer Co., Ltd., TF850H, MFR: 2.9 g/10 minutes, isotactic index: 96%) was fed to a single screw melt extruder for the layer B, and melt extrusion performed at 240° C. After removing foreign objects by a 60 μm cutoff sintered filter, by a feed block-type A/B composite T die, the polypropylene raw material C and the polypropylene raw material D were laminated on each other with a thickness ratio of 8/1 and discharged onto a casting drum the surface temperature of which was controlled to 30° C. to obtain a cast sheet. In this process, the polypropylene raw material C of the base layer was set to a face being in contact with the casting drum. Next, the film was preliminarily heated at 125° C. using a plurality of ceramic rolls and stretched 4.6-fold in the film longitudinal direction. Next, the film was introduced into a tenter-type stretching machine with its ends gripped by clips, preliminarily heated for 3 seconds at 165° C., and stretched 8.0-fold at 160° C. In the subsequent heat treatment process, the cast sheet was subjected to heat treatment at 160° C. while giving relax with 10% in the width direction, then through a cooling process at 130° C., and guided to the outside of the tenter. The clips at the ends of the film were released, and the film wound around a core to obtain a polypropylene film with a thickness of 19 μm. The properties and the evaluation results of the polypropylene film are listed in Table 1. A fiber reinforced composite material was manufactured by the method described in Manufacture Example 1. The evaluation results thereof are listed in Table 1.

### Example 3

In Example 2, the lamination configuration was changed; by a feed block-type B/A/B composite T die for three-layer lamination, the polypropylene raw material C and the polypropylene raw material D were laminated on each other with a thickness ratio of 1/58/1, and as the polypropylene raw material C for the base layer (the layer A), 85 parts by mass of Crystalline PP (a) (manufactured by Prime Polymer Co., Ltd., TF850H, MFR: 2.9 g/10 minutes, isotactic index: 96%) and 15 parts by mass of a master raw material (manufactured by Sankyo Seifun Co., Ltd., 2480K, calcium carbonate particles: 6 μm) obtained by compounding 80% by mass of calcium carbonate and 20% by mass of polypropylene were dry blended to be fed to a single screw melt extruder for the layer A. Otherwise, similarly to Example 2, a polypropylene film with a thickness of 30 μm was obtained. The properties and the evaluation results of the polypropylene film are listed in Table 1. For the evaluation of the surface properties, the surface layer that was not placed on the casting drum was evaluated. A fiber reinforced composite material was manufactured by the method described in Manufacture Example 1. The evaluation results thereof are listed in Table 1.

### Example 4

In Example 3, as the polypropylene raw material C for the base layer (the layer A), 80 parts by mass of Crystalline PP (a) (manufactured by Prime Polymer Co., Ltd., TF850H, MFR: 2.9 g/10 minutes, isotactic index: 96%) and 20 parts by mass of a master raw material (manufactured by Sankyo Seifun Co., Ltd., 2480K, calcium carbonate particles: 6 μm) obtained by compounding 80% by mass of calcium carbonate and 20% by mass of polypropylene were dry blended to be fed to a single screw melt extruder for the layer A. Otherwise, similarly to Example 3, a polypropylene film with a thickness of 30 μm was obtained. The properties and the evaluation results of the polypropylene film are listed in Table 1. For the evaluation of the surface properties, the surface layer that was not placed on the casting drum was evaluated. A fiber reinforced composite material was manufactured by the method described in Manufacture Example 1. The evaluation results thereof are listed in Table 1.

### Example 5

In Example 2, the relaxation after the transverse stretch was 0%; otherwise similarly to Example 2, a polypropylene film was obtained. The properties and the evaluation results of the polypropylene film are listed in Table 1. A fiber reinforced composite material was manufactured by the method described in Manufacture Example 1. The evaluation results thereof are listed in Table 1. The 150° C. thermal shrinkage rate in the width direction was large, and the film became deformed to slightly wrinkle during pressing.

### Comparative Example 1

In Example 2, as the polypropylene raw material C for the base layer, Crystalline PP (a) (manufactured by Prime Polymer Co., Ltd., TF850H, MFR: 2.9 g/10 minutes, isotactic index: 96%) was used (the same raw material was used for both the surface layer and the base layer). Otherwise, similarly to Example 2, a polypropylene film was obtained. The properties and the evaluation results of the polypropylene film are listed in Table 1. A fiber reinforced composite material was manufactured by the method described in Manufacture Example 1. The evaluation results thereof are listed in Table 1.

### Comparative Example 2

In Example 2, as the polypropylene raw material D for the surface layer (I), a raw material obtained by dry blending 93.3 parts by mass of Crystalline PP (a) (manufactured by Prime Polymer Co., Ltd., TF850H, MFR: 2.9 g/10 minutes, isotactic index: 96%) and 6.7 parts by mass of a master raw material (manufactured by Sankyo Seifun Co., Ltd., 2480K, calcium carbonate particles: 6 μm) obtained by compounding 80% by mass of calcium carbonate and 20% by mass of polypropylene was used (the same raw material was used for both the surface layer and the base layer). Otherwise, similarly to Example 2, a polypropylene film was obtained. The properties and the evaluation results of the polypropylene film are listed in Table 1. A fiber reinforced composite material was manufactured by the method described in Manufacture Example 1. The evaluation results thereof are listed in Table 1.

### Comparative Example 3

In Example 2, the lamination thickness ratio of the A/B layers was changed to a thickness ratio of 1/1. Otherwise, similarly to Example 2, a polypropylene film was obtained. The properties and the evaluation results of the polypropylene film are listed in Table 1. A fiber reinforced composite material was manufactured by the method described in Manufacture Example 1. The evaluation results thereof are listed in Table 1.

### Comparative Example 4

In Example 1, the lamination thickness ratio of the A/B layers was changed to a thickness ratio of 1/1. Otherwise, similarly to Example 1, a polypropylene film with a thickness of 25 μm was obtained. The properties and the evaluation results of the polypropylene film are listed in Table 1. The thickness of the layer B was large, and the liquids dropped in the measurement of the surface free energy penetrated into the network structure of the layer B as the surface layer, which made the measurement of the surface free energy impossible.

### Comparative Example 5

In Example 3, as the polypropylene raw material D for the surface layer (I) (the layer B), 50 parts by mass of Crystalline PP (a) (manufactured by Prime Polymer Co., Ltd., TF850H, MFR: 2.9 g/10 minutes, isotactic index: 96%) and 50 parts by mass of Low Melting Point PP (manufactured by Sumitomo Chemical Co., Ltd., S131, melting point: 132° C., MFR: 1.5 g/10 minutes) were dry blended to be fed to a single screw melt extruder for the layer B. Otherwise, similarly to Example 3, a polypropylene film with a thickness of 30 μm was obtained. The properties and the evaluation results of the polypropylene film are listed in Table 1. For the evaluation of the surface properties, the surface layer that was not placed on the casting drum was evaluated. A fiber reinforced composite material was manufactured by the method described in Manufacture Example 1. The evaluation results thereof are listed in Table 1. The 150° C. thermal shrinkage rate in the width direction was large, and the film became deformed to slightly wrinkle during pressing.

### Comparative Example 6

For a commercially available polypropylene matte film (manufactured by Toray Industries, Inc., YM-17), the properties and the evaluation results thereof are listed in Table 1.

For the evaluation of the surface properties of the polypropylene films of the examples and the comparative examples, the surface layer of the matte face was evaluated. The fiber reinforced composite materials were manufactured using the polypropylene films of the examples and the comparative examples by the method described in Manufacture Example 1. The evaluation results thereof are listed in Table 1.

TABLE 1

| | | | | | | | Compar- | Compar- | Compar- | Compar- | Compar- | Compar- |
|---|---|---|---|---|---|---|---|---|---|---|---|---|
| | | | | | | | ative | ative | ative | ative | ative | ative |
| | | Exam- | Exam- | Exam- | Exam- | Exam- | Exam- | Exam- | Exam- | Exam- | Exam- | Exam- |
| | | ple 1 | ple 2 | ple 3 | ple 4 | ple 5 | ple 1 | ple 2 | ple 3 | ple 4 | ple 5 | ple 6 |
| Thickness | (μm) | 15 | 19 | 30 | 30 | 19 | 19 | 19 | 19 | 25 | 30 | 25 |
| Surface | (mN/m) | 26.8 | 25.3 | 26.5 | 27.8 | 25.3 | 31.2 | 32.0 | 29.1 | — | 31.0 | 30.0 |
| free | | | | | | | | | | | | |
| energy | | | | | | | | | | | | |
| Young's | MD | 2.3 | 2.1 | 2.0 | 2.0 | 2.0 | 2.1 | 2.0 | 2.1 | 2.1 | 2.1 | 1.8 |
| modulus | GPa) | | | | | | | | | | | |
| | TD | 5.0 | 3.8 | 3.5 | 3.3 | 4.0 | 3.6 | 3.5 | 3.7 | 4.2 | 3.7 | 3.7 |
| | (GPa) | | | | | | | | | | | |
| 120° C. | (%) | 0.2 | 0.1 | 0.2 | 0.2 | 3.2 | 0.2 | 0.2 | 0.2 | 0.3 | 0.9 | 0.4 |
| Thermal | | | | | | | | | | | | |
| shrinkage | | | | | | | | | | | | |
| rate in | | | | | | | | | | | | |
| width | | | | | | | | | | | | |
| direction | | | | | | | | | | | | |
| Center line | (nm) | 57 | 263 | 430 | 520 | 255 | 24 | 480 | 180 | 60 | 400 | 80 |
| average | | | | | | | | | | | | |
| roughness | | | | | | | | | | | | |
| Ra | | | | | | | | | | | | |
| Maximum | (nm) | 680 | 4,100 | 9,800 | 12,500 | 3,800 | 336 | 5,600 | 3,500 | 650 | 10,800 | 2,200 |
| height | | | | | | | | | | | | |
| Rmax | | | | | | | | | | | | |
| 150° C. | (%) | 3 | 3 | 2 | 2 | 4 | 2 | 2 | 2 | 5 | 7 | 7 |
| Thermal | | | | | | | | | | | | |
| shrinkage | | | | | | | | | | | | |
| rate in | | | | | | | | | | | | |
| longitudinal | | | | | | | | | | | | |
| direction | | | | | | | | | | | | |
| 150° C. | (%) | 8 | 7 | 6 | 7 | 21 | 5 | 6 | 5 | 18 | 22 | 19 |
| Thermal | | | | | | | | | | | | |
| Shrinkage | | | | | | | | | | | | |
| rate in | | | | | | | | | | | | |
| width | | | | | | | | | | | | |
| direction | | | | | | | | | | | | |

| | | | | | | | | | | | |
|---|---|---|---|---|---|---|---|---|---|---|---|
| Surface roughness | — | Pass | Pass | Pass | Pass | Pass | Pass | Pass | — | Pass | Fail |
| after pressing | | | | | | | | | | | |
| Mold releasability | — | Pass | Pass | Pass | Pass | Fail | Fail | Fail | — | Fail | Fail |
| from fiber reinforced | | | | | | | | | | | |
| composite material | | | | | | | | | | | |
| Matte texture of | — | C | B | A | B | D | B | D | — | B | D |
| fiber reinforced | | | | | | | | | | | |
| composite material | | | | | | | | | | | |

1-11. (canceled)

12. A polypropylene film comprising a surface layer (I) with polypropylene as a main component at least on one face of a base layer, wherein surface free energy of the surface layer (I) is 15 mN/m or more and less than 28 mN/m.

13. The polypropylene film according to claim 12, wherein both a Young's modulus E_{MD} in a longitudinal direction and a Young's modulus E_{TD} in a width direction are 2.0 GPa or more.

14. The polypropylene film according to claim 12, wherein a value of a ratio E_{MD}/E_{TD} of a Young's modulus E_{MD} in a longitudinal direction to a Young's modulus E_{TD} in a width direction is 0.2 to 1.5.

15. The polypropylene film according to claim 12, wherein a 120° C. thermal shrinkage rate in a width direction is 1% or less.

16. The polypropylene film according to claim 12, wherein a 150° C. thermal shrinkage rate is 0.1 to 20% both in a longitudinal direction and in a width direction.

17. The polypropylene film according to claim 12, wherein center line average roughness Ra of the surface layer (I) is 10 to 150 nm.

18. The polypropylene film according to claim 12, wherein center line average roughness Ra of the surface layer (I) is 200 to 500 nm and a maximum height Rmax of the surface layer (I) is 1,000 to 5,000 nm.

19. The polypropylene film according to claim 12, wherein center line average roughness Ra of the surface layer (I) is 200 to 1,000 nm and a maximum height Rmax of the surface layer (I) is 5,000 to 15,000 nm.

20. The polypropylene film according to claim 12, wherein
the base layer contains polypropylene and particles with an average particle diameter of 1 to 10 μm, and
a rate (%) of a thickness of the surface layer (I) to a thickness of the entire polypropylene film is 25% or less.

21. A mold release film comprising a polypropylene film including a surface layer (I) with polypropylene as a main component at least on one face of a base layer, wherein surface free energy of the surface layer (I) is 15 mN/m or more and less than 28 mN/m.

22. The mold release film according to claim 21 for use in mold pressing for a fiber reinforced composite material.
